(19) United States
(12) Patent Application Publication
(10) Pub. No.: US 2002/0041658 A1
(43) Pub. Date: Apr. 11, 2002

(54) Variable word length data memory

(76) Inventors: Alva Henderson, Sherman, TX (US); Francesco Cavaliere, Plano, TX (US)

Correspondence Address: TEXAS INSTRUMENTS INCORPORATED, P O BOX 655474, M/S 3999, DALLAS, TX, 75265

(21) Appl. No.: 09/866,159

(22) Filed: May 25, 2001

Related U.S. Application Data
(62) Division of application No. 09/305,891, filed on May 5, 1999.
(60) Provisional application No. 60/087,957, filed on Jun. 4, 1998.
(60) Provisional application No. 60/089,572, filed on Jun. 17, 1998.

(51) Int. Cl. H04M 1/64

(52) U.S. Cl. 379/67.1

(57) ABSTRACT

A variable word length data memory. The data memory disclosed has standard 16-bit word memory operation. The variable word length enables increased software efficiency in implementing software buffers using single memory locations parallel to the memory words as tags. Low-cost, efficient logic processing is enabled through a flag processor instruction set. This instruction set provides direct reference to flag memory, status test flags, and latched condition states.

### BACKGROUND AND SUMMARY OF THE INVENTION

The present invention relates to microcomputer memory architecture, and particularly to providing variable word length memory in a microcomputer without increased processing overhead.

### BACKGROUND

Memory Architecture Design Considerations

The design of a microprocessor requires a decision as to the length of words that will be used to hold data. The decision as to the number of bits that will comprise a word must account for several design parameters. Such parameters include code efficiency, memory utilization, execution time, and overall cost. Generally, each parameter is given the same weight in the decision process. This equal weighting is especially prevalent in general purpose processors for which a particular use, or even class of uses, may not yet be known. However, a microprocessor, such as a dedicated-DSP (or “ASIC”) can be designed for a specific use. In such cases, the design parameters listed above may taken on different weights as to their overall importance in the processor architecture.

### BACKGROUND

Word Length Choice

The choice of providing a long word length, for example, 64-bits, generally results in lower overall processing time. With a long word length, more data is read from or written to memory at a time. A 64-bit architecture also includes a 64-bit data path to transfer data to and from memory a word at a time. Therefore, multiple reads or writes to perform complex tasks are not often required. However, long word length often results in poor memory utilization. Most instructions, even for 64 bit processors, do not require 64 bits in order to be uniquely identified and executed by the processor. Further, most data kept in memory does not make use of 64 bits. That is, typically a word in memory identifies a single number, such as 32,543, or a single alphanumeric character, such as “H”. Although a 64 bit word allows for numbers higher than the trillions to be stored, most common alphanumeric characters can be stored in 8 bits or less. Thus, each alphanumeric character results in at least 56 bits of unused memory per word. Software can be used to increase memory utilization. Software techniques include packing and unpacking data bits or using words in native bit formats. However, such techniques can have an undesirable impact on both the code efficiency, the time of code development, and the length of time required to execute an instruction. Without such techniques, the higher cost of a wider data path and larger chip area can make any resultant speed advantage unjustifiable in light of inefficient utilization of expensive memory.

The choice of providing a short word length, for example, 8 bits, can result in some relatively complex data functions becoming impossible to implement. A short word length requires a smaller data path but fewer bits of data are read from or written to memory at a time. Therefore, multiple reads or writes may be required to perform some tasks. Conversely, an 8 bit architecture results in more efficient memory utilization, as explained below. If a short word length is chosen, the overall cost of production is lowered. However, overall chip performance is also lowered commensurate with overall cost.

### Background

Byte Lengths

Choice of a 16 bit architecture represents a cost vs. performance compromise. Data paths for 16 bit architectures are relatively narrow. However, such data paths provide acceptable performance for applications which are not highly dependent on speed such as low resolution digital signal processors (or DSPs).

There are two data lengths which are found to occur frequently in data processing. A length of 8 bits is frequently found because of the general use of data formats such as ASCII. ASCII represents 256 different characters using an 8 bit format. A 1-bit data length representation exists in data processing algorithms. These single pieces of information are useful where implementations of flags or logical trees are desired.

Both 8-bit and 1-bit data lengths can be processed in standard 16-bit word architectures. In 16-bit word architectures, data lengths of 8-bits are referred to as bytes. Bytes of information can be processed separately in such architectures.

There are several implementations of 1-bit data in 16-bit word architectures which are currently in use. For example, software (or firmware) can be written so as to track 16 different 1-bit words in a single word of memory. The software then masks all bits but the one needed for the particular instruction. Another approach is to use an entire word of memory to represent 1-bit of information. This approach is accomplished by setting all 16 bits of a word to assume the value of the 1-bit desired, for example, either all 0s or all 1s. Both of these approaches suffer from increased overhead. In the software masking approach, resolving a single logic bit from a 16-bit word requires an increase in processing steps, and thus a longer processing time. Use of an entire word of memory for 1-bit of logic results in inefficient use of storage space.

A third approach is the use of tagged memory. Such memory is used in special purpose processors wherein there is a need to characterize the type of data that is tagged e.g, integer, string, etc. Currently, processors using the tagged 1-bit memory approach to store logic level (or flag type) data also require increased overhead. The 1-bit memory array is addressed (read or written) separately from the 16-bit word memory array. The memory arrays are not connected in parallel such that a read or write to one address retrieves the information from both.

Typically the internal memory word length matches the width of the data path register length. Some processors permit byte (or half-word) manipulation in addition to reading and writing of full words. However, most processors do not make use of single bit memory locations, instead using the software techniques outlined above.

Variable Word Length Data Memory

The present application discloses a more efficient method of storing and manipulating data of different bit lengths. Data of varying word lengths such as full 16-bit data words, 8-bit half words, and 1-bit data are handled. As in most 16-bit architectures, the lower 16-bits in this architecture are read into two byte-wide (8-bit) registers. By virtue of this construction and arrangement, zero overhead reading and writing of data bytes to and from this 16-bit data memory is provided. All bytes are right-justified in a byte-long central processing unit (CPU). Therefore, data is written and read efficiently as bytes within the CPU.

For the handling of 1-bit flags or logical data, a 1-bit data RAM is connected in parallel with the 16-bit data RAM, effectively creating a 17-bit RAM. An address source is shared by both the 1-bit data RAM and the 16-bit data RAM every CPU cycle. As a result, the 16-bit long data RAM and the 1-bit long data RAM form one addressable data word that is effectively 17-bits long. However, data memory write control is independent for each of these two RAMs.

Every read access of a 16-bit data RAM location also results in reading the value that is stored in the corresponding 1-bit data RAM. This 1-bit value is then stored in a status-register. A program decision can then be made based directly upon the value of this stored status-register bit.

When 16-bits of data are written to the 16-bit data RAM, the 17^{th}-bit, or the bit that is stored in the 1-bit data RAM is not altered. A 1-bit arithmetic logic unit (ALU) and a class of program instructions are provided for reading, writing, modifying and testing the 1-bit data RAM, without modifying the stored data content in the 16-bit data RAM. In this way, a direct procedure is provided to manipulate the 1-bit data without the need for 16-bit overhead or utilization, and a more efficient and natural program procedure is provided to manage algorithmic decisions.

An advantage of this disclosure is that efficient memory utilization concerning logical bits and flags lends itself to simpler ALU structures that do not require encoding and decoding logic, and more natural logic decision making in associated software programs.

One particularly advantageous use for this extension bit is for conditional execution of instructions, particularly branch and jump instructions.

For another example, an instruction can be executed on a range of locations, with a conditional dependance on the status of the extension bit at each address.

For another example, as further described below, the extension bit can be used as a flag for chaining together multiple words to perform extended precision operations.

For another example, the extension bit can be used as tag, so that execution will branch on tag, if the extension bit is set.

For another example, the extension bit can be used as a flag to mark the boundary of a circular buffer. This is particularly useful, for example, for executing finite impulse response filter functions.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 depicts a block diagram of the memory organization of the variable length data memory array.

FIG. 2 depicts a block diagram of the memory organization of a 16-bit data memory array.

FIG. 3 depicts a block diagram of the relative flag addressing offset derivation.

FIG. 4 depicts the data memory organization of byte, word, and flag data.

FIG. 5 depicts a bit logic unit in combination with flag registers.

FIG. 6 depicts a FIR filter structure.

FIG. 7 depicts the operation of the circular buffer in the presently preferred embodiment.

FIG. 8 depicts a block diagram of the MSP58P70 architecture.

FIG. 9 depicts a telephone answering machine which incorporates variable length data memory.

### DETAILED DESCRIPTION OF THE PREFERRED EMBODIMENTS

The numerous innovative teachings of the present application will be described with particular reference to the presently preferred embodiment. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

Preferred System Context

The system context of the presently preferred embodiment is a mixed signal processor (MSP) such as the MSP58P70 by Texas Instruments. The Product Preview for this chip describes further details of this sample embodiment, and is hereby incorporated by reference. The Product Preview is available, as of the effective filing date of this application, from Texas Instruments, Dallas, Tex. A functional block diagram of the preferred system is shown in FIG. 8. This figure depicts a block diagram of the MSP58P70 architecture.

The MSP58P70 is a MSP with enhanced microcontroller features and a limited digital signal processor (DSP) instruction set. the DSP functions are supported by a basic multiplier/accumulator structure. In addition to the DSP functions, the chip implements efficient string and-bit manipulation features

A microprocessor, or more simply a processor, according to the preferred embodiment is of general utility, and finds particular utility in applications such as high speed calculators and medium speed digital signal processor (DSP) systems. The processor can be used with a variety of different memory configurations and with a variety of different peripheral devices to create a wide variety of application-specific consumer products.

The basic architecture of the processor of the presently preferred embodiment includes a high speed computational-unit (CU) and a full-featured data-memory-address-unit (DMAU). The processor die or chip provides separate data and program memory spaces, thus permitting parallel access and maximum computational throughput. In order to achieve minimum power consumption, static logic implementations form the processor's functional blocks, with major functional blocks being disabled when not in use. A number of different internal memory sizes and types can be combined with customized peripheral devices and interrupt logic to provide a wide variety of customized devices, each of a different utility.

In the presently preferred embodiment, but without limitation thereto, program and data memory is restricted to internal memory blocks that can not be expanded by the use of external memory. Program memory comprises ROM, EPROM, or OTP, for example the quantity 64K of 17-bit words. Data memory is RAM. In accordance with the spirit and scope of the invention, different embodiments feature different combinations of program and data memory sizes, with program memory generally comprising at least 16K of 17-bit words. When mass data storage is required, an auxiliary data memory peripheral interface can be provided.

In order to merge the requirements of numerical processing in both the calculator field and the DSP field, the processor provides a 16-bit word length. This choice also sets the processor's program address limit to generally 64K words, each of a 16-bit length.

Processor Architecture

With reference to FIG. 8, a processor 10 in accordance with the preferred embodiment comprises a number of major sub-blocks, including a program-data memory block 11 and a data-memory block 12. The major sub-blocks comprise the above-mentioned computation-al-unit or CU 13 and the above-mentioned data-memory-address-unit or DMAU 14, a program-counter unit (PCU) 15, and an instruction decoder 16. Other functions are provided by a repeat or chain-counter register 17, a status register 18, two timers 19 and 20, interrupt logic 21, and a peripheral expansion interface 22.

A 17-bit data bus (DB) 23 provides communication between the functional blocks within processor 10. Most of the registers within processor 10 have read and write access to DB 23. The bus drivers (not shown) are static devices in order to avoid unnecessary power consumption, and in order to provide a maximum logic propagation time. The minimum instruction period of processor 10 is about 100 ns, with a 10 nHz processor clock (not shown) being provided.

Data memory 12 of FIG. 8 is organized as a plurality of 17-bit parallel words. The number of words varies in accordance with the application to which processor 10 is applied, but the range of 256 to 2048 words is exemplary, with 1152 words being indicated in FIG. 8. Each address 51 that is provided by DMAU 14 causes 17 bits of data to be addressed. These 17 bits will be operated on in a number of different ways, depending upon the instruction being executed. For most instructions this data is interpreted in a 16-bit word format. Two byte instructions, such as LACB and SACB cause processor 10 to read or write data in an 8-bit word format, also called a byte format. This byte format mode causes the processor hardware to read or write either the upper or the lower byte of the addressed 16-bit word, and the fetched byte is right-justified on DB 23.

In a flag-data mode, an instruction operates only on the 17^{th} bit of the fetched word. The 17^{th} bit is always read and then loaded into the MTAG bit of FIG. 8's status-register 18 for all reads of data memory 12, thus providing for the tagging of either word or byte data. For byte mode, two consecutive bytes have the same tag associated therewith. Tagged data is used by FIR, FIRK, COR and CORK instructions to emulate a circular buffer. The MTAG bit of the status-register can also be tested as a condition for branch/call instructions, or it can be combined with other test conditions and other flags to generate new conditions.

MSP58P70 Architecture

The MSP58P70 has a powerful instruction set. The instructions can individually address bit, byte, word or a string of words or bytes. The program memory is 17-bit wide and the entire 17-bit width is used for instruction set encoding. Programs are executed from internal program memory. Execution from external memory is not possible. Both the program and data memory of the MSP58P70 is restricted to internal blocks and can not be expanded externally. In the presently preferred embodiment, the program memory is One Time Programmable (OTP) ROM and limited to 32K 17-bit words, 2K of which is reserved for internal test code and is not accessible by user programs. Also in the presently preferred embodiment, the data memory is static RAM and is limited to 1024 17-bit words, 16 bits of which are an arithmetic value while the 17th bit is used as a flag or tag.

17-Bit Memory

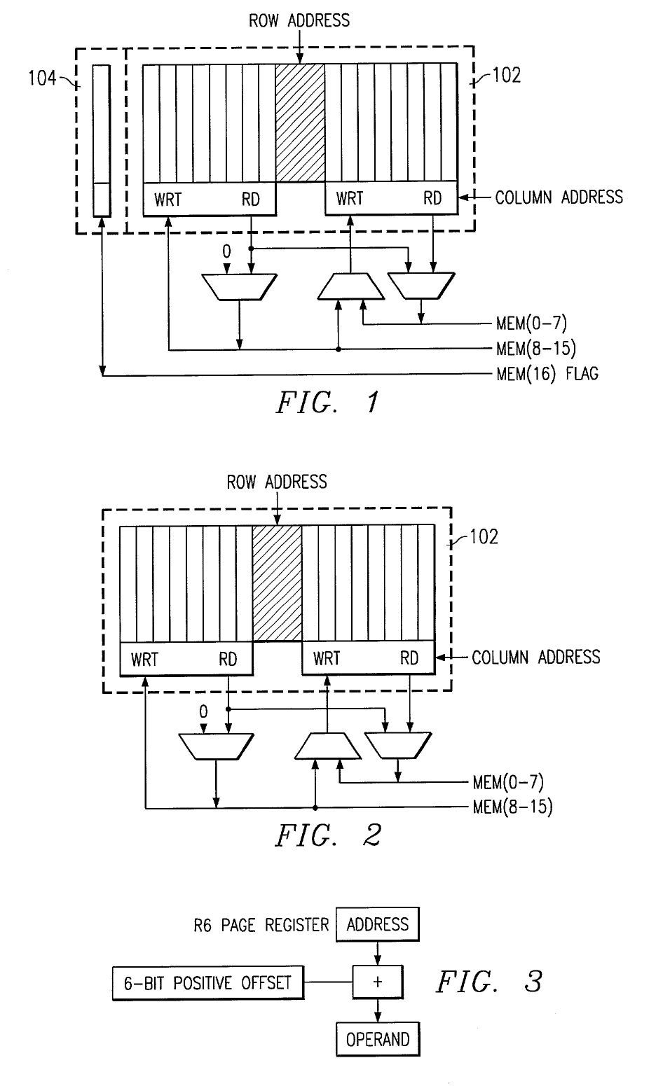

The data memory array of the MSP is organized in 17-bit words. FIG. 2 depicts a block diagram of the memory organization of a typical 16-bit data memory array. The memory array 102 is organized such that the low order byte of the word, bits 0-7, is accessed by lines 0-7 of the memory array data path. However, the high order byte of each word can be read into an internal register of the MSP by lines 0-7 of the memory array data path as well as onto lines 8-15 of the data path. A byte of data transmitted on memory array data path lines 8-15 can be written to either the high or low order byte of a word in the memory array 102. Byte-wise instructions in the MSP instruction set ensure that byte data is appropriately multiplexed to either the high or low order byte.

FIG. 1 depicts a block diagram of the memory organization of the variable length data memory array. A 1-bit memory array 104 is connected in parallel with a 16-bit memory array 102, effectively creating a 17-bit memory array. An address source is shared by both the 1-bit memory array and the 16-bit memory array. The entire contents of the 17-bit word can be read with one address. However, write control is independent for each of these two arrays. Write control for the lower 16-bits of the word is identical to that of the memory array described in FIG. 2. In byte or word writes, no data is written to the 17th-bit.

Data Memory Formats

The data memory block depicted in FIG. 1 is physically organized as a 17 bit parallel word. The 17th bit can be used as tag or flag bit for complex branch conditions. That is, a branch without a corresponding test can occur on the basis of the flag bit. A third data mode is flag data where instructions of the MSP operate on only the 17th bit.

In the presently preferred embodiment, the size of MSP58P70 data memory block is 1024 17-bit locations. Each address provided by the direct memory access unit (or DMAU) causes 17 bits of data to be addressed. These 17 bits are operated on in different ways depending on the instructions being executed. For most instructions, the data is interpreted as 16-bit word format. Byte instructions like MOVB (instructions ending in a B generally use byte addressable arguments) cause the processor to read or write data in 8-bit byte format. Byte mode causes the hardware to read or write either the upper or lower byte of the 16-bit word based on the Least Significant Byte (LSB) of the address (the address is a byte address, not a word address), automatically right justifying the word on the data bus.

Data Memory Organization and Addressing

The MSP has instructions to address bits, bytes, words, and strings in both data memory and program memory. FIG. 4 illustrates the data memory organization of byte, word, and flag data. Data memory is accessed in bytes by the hardware. The instruction used to retrieve the data determines whether the data retrieved is treated as a byte, word, string, or flag.

Individual bytes can be addressed by the MSP. Generally, MSPs address individual bytes only with load or store instructions (these instructions typically end with a “B” suffix). Otherwise, an entire word is addressed. The byte addressing load and store routines can take advantage of physically multiplexing the high order byte of a word into the low order byte of memory or a retrieval register.A byte string is one byte times the length of the string. The length of the string is stored in the string register (STR). Byte string data is fetched a byte at a time until the string length (in bytes) is reached. A word is composed of two consecutive bytes. Instructions which operate on words have internal hardware which appropriately increment the byte address to load two consecutive bytes in one clock cycle. Like a byte string, a word string uses the STR register to receive a string of words that is STR words long.

Flag (or tag) addressing uses linear addressing from 0 to the size of data memory, in words. In flag addressing, only the 17th bit of each word is addressable. However, when a word or byte data memory location is read, the corresponding flag for that location is always loaded into the TAG bit of the status register (STAT). In this case, the flag address used to read the 17th bit is the effective address created by right shifting 1 bit of the word or byte address. If string instructions are used, the flag bit of the last memory location of the string is loaded into the TAG bit of STAT. Global or relative flag addressing, described below, is used to address flags. In the presently preferred embodiment, flag bits can be individually set or reset using class 8 instructions.

Flag Addressing

In the presently preferred embodiment, the MSP machine level instruction set is divided into classes according to field references associated with memory, hardware registers, and control fields. The MSP implements a class of instructions (class 8) intended to be used to access the 17th bit (the flag bit) of each word located in data memory. All flag instructions execute in 1 instruction cycle. Using flag addressing the flag bit can be loaded, saved or perform various logical operations without effecting the remaining 16 bits of the selected word, Two addressing modes are provided. The first addressing mode is called Global flag addressing. Global flag addressing has bit 0 set to zero and a six bit field (b1-b6) defines the flag address. Global addressing of flags provides access to 64 global flags from a base offset of 0000 h. These flags are located in the first 64 addresses in memory. The second mode is called Relative Flag addressing. Relative Flag addressing has bit 0 set to one and the same six bit field defines the flag address relative to the contents of a register, R6, i.e., effective address=(content of R6)+(6 bit offset). FIG. 3. depicts a block diagram of the relative flag addressing offset derivation. Relative addressing of flags provides access to 64 different flags from a positive offset value stored in the PAGE (R6) register of the MSP.

In the following instruction examples, bits 0 to 6 of flag instructions are indicated by {flagadrs} and would be substituted into the syntax of the instruction by a known value during execution. For example, the instruction AND TFn, {flagadrs} can be written as follows:

| | |
|---|---|
| AND TF1, *0x1 | global flag addressing, flag address is |
| | 0x21 absolute; or |
| AND TF2, *R6 + 0x21 | relative flag addressing, flag address is |
| | R6 + 0x21 absolute |

Where TF1 and TF2 are test flags (bits 14 and 15, respectively) of the MSP's 17-bit Status Register. R6 indicates that the page register is the source of the flag address offset. If bit 0 of either of these instructions is 0, then bits 1 to 6 of the {flagadrs} are taken as the bit address starting from data memory location 0. If bit 0 is 1, then bits 1 to 6 are used as an offset from page register to compute the a relative address:

| Flag | {flagadrs} | Flag addressing mode encoding, flagadrs | |
|---|---|---|---|
| Address | Syntax | 6 5 4 3 2 1 | 10 |
| Modes | | flagaddress bits | global/relative bit |
| Global | *dma6 | dma6 | 0 |
| Relative | *R6 + offset6 | offset 6 | 1 |

Logic and Bit Instructions

In the presently preferred embodiment, the class of instructions which act on the 17th-bit are for use with both logical and flag type applications. This class of instructions provides a flexible and efficient means to make complex logical decisions. Instead of making a sequence of single bit decisions and constructing a logical statement through a branch decision tree, the program can sequentially combine several status conditions to directly construct a final logic value (TF1 or TF2) which can be used to control a subsequent branch or call.

This class includes two sub-classes. Sub-class 8a instructions update one of the test flags (TF1 or TF2) with a logical combination of the old test flag value and an addressed memory flag value. Sub-class 8b instructions provide a flexible means of logically combining the test flag (TF1 or TF2) with a status condition and storing the results back to the test flag.

In the presently preferred embodiment, the instructions are represented to the MSP by the following operational codes:

| | | | | | | | |
|---|---|---|---|---|---|---|---|
| bit | 16 15 14 13 12 | 11 | 10 | 9 8 7 | 6 5 | 4 3 2 | 1 0 |

| | | | | | |
|---|---|---|---|---|---|
| 8a | 1 0 0 1 1 | flg | Not | 8acode | flagadrs |

| | | | | | | |
|---|---|---|---|---|---|---|
| 8b | 1 0 0 1 0 | flg | Not | cc | Rx | 8bcode |

| | | | | | |
|---|---|---|---|---|---|
| Rflag | 1 0 0 0 0 | 0 | 1 | 0 1 1 | flagadrs |
| Sflag | 1 0 0 0 1 | 1 | 0 | 1 0 1 | flagadrs |

The 8a code indicates the particular bit instruction to be performed.

For example:

| 8acode | Mnemonic | Description |
|---|---|---|
| 000 | MOV TFn, {flagadrs} | Load single bit effective flag |
| | | memory address value *or it's |
| | | compliment to either TF1 or TF2 |
| | | in the status register. |
| 010 | OR TFn, {flagadrs} | Logically OR either TFl or TF2 |
| | | with the single bit effective flag |
| | | memory address (or inverted |
| | | value if N = 1) addressed by the |
| | | instruction and store back to TF1 |
| | | or TF2 respectively. |
| 100 | AND TFn, {flagadrs} | Logically AND either TF1 or |
| | | TF2 with the single bit effective |
| | | flag memory address (or inverted |
| | | value if N = 1) addressed by the |
| | | instruction and store back to TF1 |
| | | or TF2 respectively. |
| 110 | XOR TFn, {flagadrs} | Logically exclusive OR either |
| | | TF1 or TF2 with the single bit |
| | | effective flag memory address |
| | | (or inverted value if N = 1) ad- |
| | | dressed by the instruction and |
| | | store back to TF1 or TF2 re- |
| | | spectively. |
| 001 | MOV {flagadrs}, TFn | Store TF1 or TF2 to a memory |
| | | location. |
| 011 | RFLAG {flagadrs} | Reset single bit effective flag |
| | | memory address value to 0. |
| 101 | SFLAG {flagadrs} | Set single bit effective flag mem- |
| | | ory address value to 1. |

Likewise, the 8b code represents the particular 8b instruction type to be performed.

| 8bcode | Mnemonic | Description |
|---|---|---|
| 00 | MOV TFn, {cc} [,Rx] | Load a logic value of the tested |
| | | condition to one of the test flag |
| | | bits in status register TF1 or |
| | | TF2. |
| 01 | OR TFn, {cc} [,Rx] | Logically modify one of the two |
| | | test flags in the status register |
| | | (TF1 or TF2) by ORing it with |
| | | the status condition specified. |
| 10 | AND TFn, {cc} [,Rx] | Logically modify one of the two |
| | | test flags in the status register |
| | | (TF1 or TF2) by ANDing it with |
| | | the status condition specified. |
| 11 | XOR TFn, {cc} [,Rx] | Logically modify one of the two |
| | | test flags in the status register |
| | | (TF1 or TF2) by exclusive |
| | | ORing it with the status condi- |
| | | tion specified. For this instruc- |
| | | tion, the polarity of N is inverted |
| | | (N = 1 for XOR, N = 0 for |
| | | XNOR). |

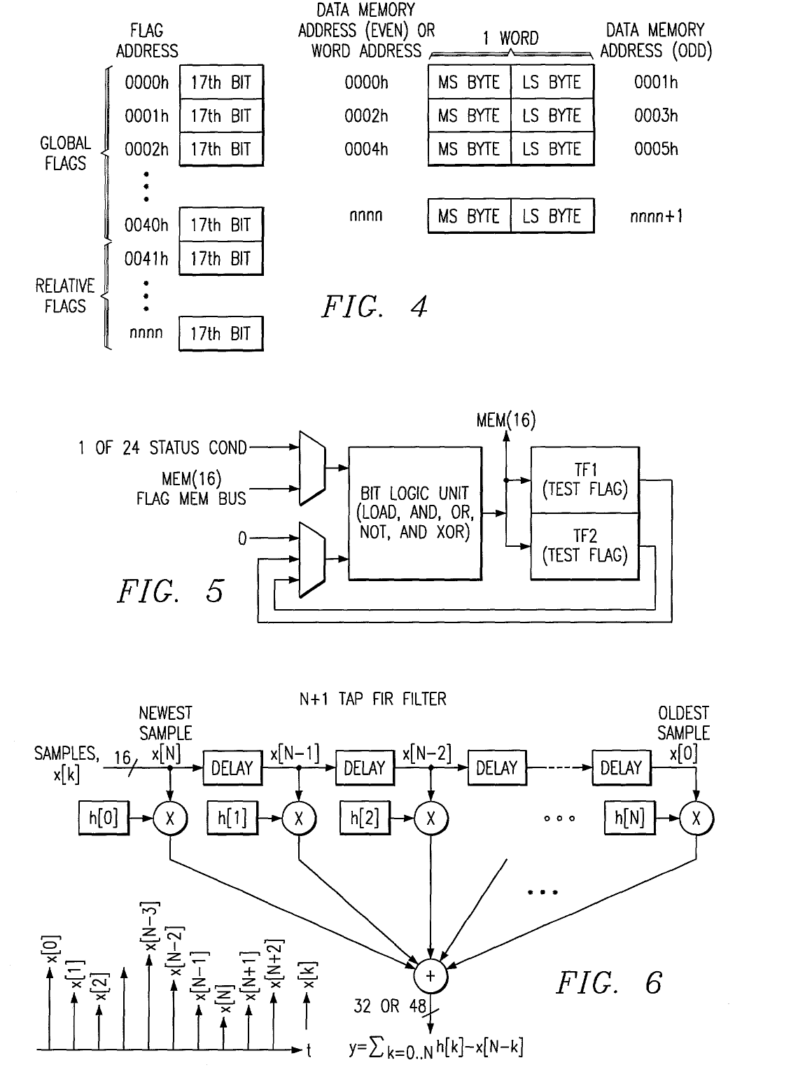

FIG. 5 depicts a bit logic unit in combination with flag registers. The bit logic unit is a single bit arithmetic logic unit (ALU) that operates on tag and flag data. The class 8 instructions of the MSP described above control this BLU. Test flags TF1 and TF2 are bit-long logic indicators physically located in the status register (SR) of the MSP. However, both TF1 and TF2 can be written and read as registers. Mem(16) is connected to the 17th line of the databus to receive the tag/flag bit. The status condition is provider by a multiplexor connected to the data bus. The BLU efficiently generates decision flags for program control. Results of bit logic operations are stored in the tag/flag (17th-bit) of memory or in the TF1 or TF2 bits of the STAT. An example of the generation of bit logic, in the presently preferred embodiment, follows:

Given the programming instruction

If{( (value1=0 AND speak) OR (NOT(value2>0)))

AND last_frame AND inhibit AND ic7)} goto END

where: Speak ,last_frame, inhibit, and ic7 are flags maintained in flag memory; and value1, value2 are 16 bit data values stored in parallel memory, an assembly program using the BLU, flag memory, and flag processor would be coded:

| | |
|---|---|
| LTF,1,speak | ;LOAD speak flag to TF1 |
| LAC,a0,value1 | ;LOAD value1 to accumulator0 |
| ANDCF,1,AZ | ;AND status condition of accumulator equal |
| | to zero with TF1 |
| LAC,a0,value2 | ;load value2 to accumulator to get status |
| | value |
| LCF,2,!AGT | ;LOAD the compliment of ACC Greater than |
| | zero to TF2 |
| ANDF,2,last_frame | ;AND of last_frame flag with TF2 |
| ORCF,1,TF2 | ;OR of TF1 and TF2 result in TF1 |
| ANDF,1,inhibit | ;AND of inhibit flag and TF1 |
| ANDF,1,ic7 | ;AND of ic7 flag and TF1 |
| BR,TF1,END | ;branch to END if TF1true |

Circular Buffering

In addition to efficient branching, the tag/flag data memory can be linked to specialized hardware/software to provide very efficient circular buffers for DSP routines such as FIR filters. Without such a tag/flag bit, circular buffering would require both a buffer header and a word indicating the length of the buffer to be used in memory for each circular buffer. The tagged 16-bit data can also be extended to link hardware/software in the manipulation of other data buffering requirements. For example, the 1-bit tag may be used to indicate the physical end of one display buffer, causing an interrupt to occur when the last buffer value is read by a liquid crystal display (LCD) control state machine.

The MSP58P70 is designed to perform DSP functions at a medium performance. Fundamental to many filtering algorithms, a main function of DSPs, is a FIR structure. FIG. 6 depicts a FIR filter structure. An FIR structure requires several parallel operations to execute for each tap of the filter. Each tap has 1 multiply and 1 accumulation to obtain the output for N+1 taps which is represented by:

y=Σ_{k=0..N}h[k]x[N−k]

For N taps, ideally, 2N multiply and addition operations are required.

In the presently preferred embodiment, four instructions, FIR, FIRK, COR, and CIRK are implemented to compute this equation.

FIR and FIRK instructions perform 16×16 bit of multiply and 32 bit accumulation operation (per tap) in 2 clock cycles. When used with a preceding RPT instruction N+2 tap FIR executes in 2 times the tap number or 2(N+2) clock cycles. FIRK is used to perform FIR tap filter section using program memory to store the fixed filter coefficients (pointed by DP) and data memory to store the variable sample values (pointed by Rx). The FIR instruction executes the same function on two sets of operands, both of which are stored in data memory. FIRK is useful for fixed filters and requires the minimum amount of data memory. FIR instruction is useful for adaptive filtering or applications where coefficients are provided from an external source.

COR and CORK instructions can perform 16×16 bit multiply and 48 bit accumulation in 3 clock cycles. When used with a preceding RPT instruction N+2 tap FIR executes in 3 times the tap number or 3(N+2). The COR and CORK instruction is identical in operation and arguments, except it adds an additional 16 bit extended accumulate cycle to prevent arithmetic overflow common in auto-correlation filters.

FIR (COR) instructions: To use FIR (COR) instructions, some initial setup is required. A consecutive Rx pair {Rxₑᵥₑₙ, Rxₑᵥₑₙ+1} should be chosen with Rxₑᵥₑₙ pointing to the data memory sample buffer area (sample_buf) and Rxₑᵥₑₙ+1 pointing to data memory coefficient array area (coeff_array). The MR register should be loaded with the first coefficient, h[0]. FIR (COR) can now execute with repeat instruction for N taps. The value of Rxₑᵥₑₙ pair is incremented during execution. After execution is complete, the last value of Rxₑᵥₙ points to sample buffer location where new sample data can be stored. FIRK (CORK) instructions: FIRK (CORK)instructions work exactly the same was as FIR(COR) instructions, except the coefficient array is located in program memory 0. Instead of loading Rxₑᵥₑₙ+1 with the pointer to coefficient array in data memory, data pointer, DP, is loaded with value of coefficient array, coeff_array, which is a essentially look up table usually stored in program ROM.

The manipulation of sample buffers by a DSP is generally done using circular buffering. Circular buffering usually requires a register, a parallel counter, and a parallel comparator to implemented. Further, the register, parallel counter and parallel comparator cannot be shared by concurrent circular buffers. Use of the tag/flag memory bit to implement circular buffers eliminates the need for implementation of this usual circular buffer overhead. In the presently preferred embodiment, the number of circular buffers which can be written is limited only by the size of the data memory.

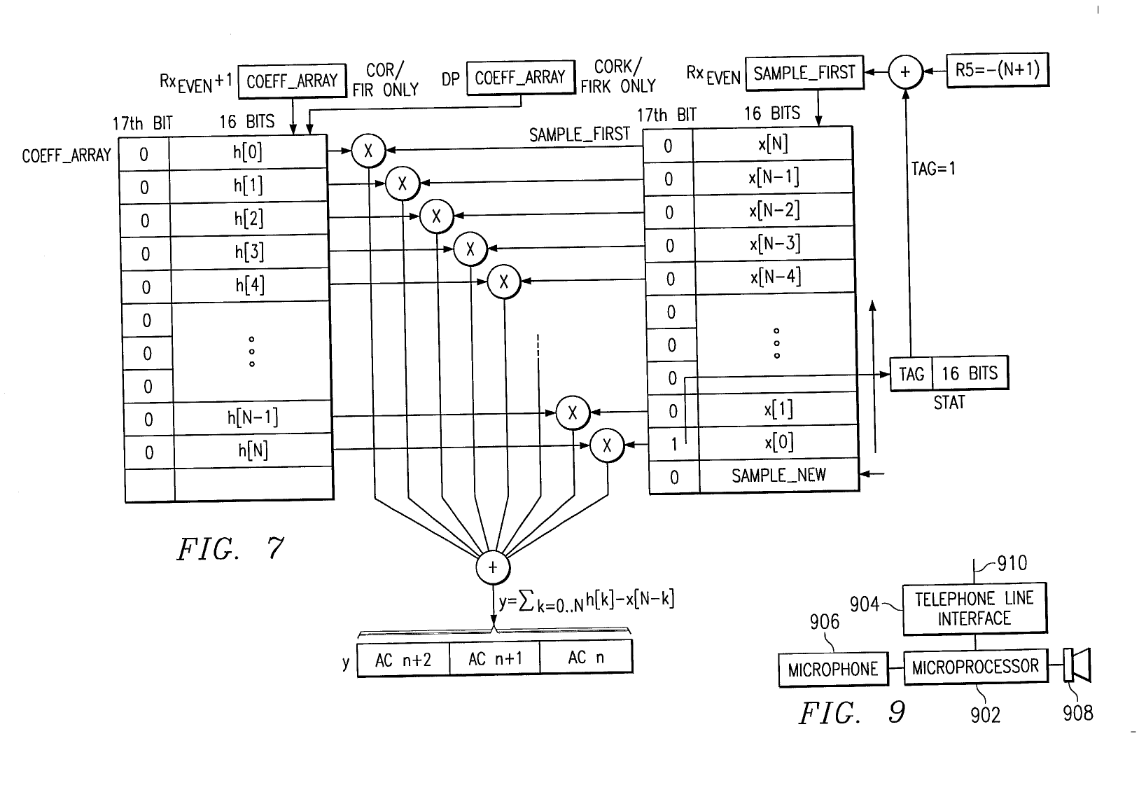

Repeated use of all filter instructions are done with circular buffer where new samples are loaded into the sample buffer in a circular fashion. FIG. 7 depicts the operation of the circular buffer in the presently preferred embodiment. A circular buffer is created by setting the TAG bit of Nth location of the sample buffer to 1. Filter instructions interpret the data memory TAG bit as a circular buffer marker. In FIG. 7, the TAG bit of Nth location of sample_buf, i.e., location sample_buf+N, is set to 1. When the filter instruction finds TAG set to 1 during execution in sample buffer, the value in R5 will be added instead of incrementing Rxₑᵥₑₙ. R5 is usually loaded with a negative value of sample buffer length before execution of any filter instructions, to point to the beginning of buffer. For the circular buffer to work consistently, the status register (STAT) should be saved after completion of filter instructions to a temporary variable and reloaded with this value just before executing the filter instructions. In FIG. 7, the sample buffer starts at sample_first. Sample_first is initially loaded with the address of the start of the buffer. After the filter instruction is executed once, the new Rxₑᵥₑₙ will point to (N+1)^{th} location from the beginning of the buffer. The new sample is stored in this location, the Rx^{even} becomes the new value of sample_first. The effect of a circular buffer implemented in this way will cause every new sample x[k] and the pointer Rxₑᵥₑₙ to move backwards, which is equivalent to replacing the oldest sample. The number of data memory locations used by implementing this circular buffer is N+1, where N is the number of filter TAPs. This is consistent with the FIR filter operation and works properly with any MSP58P70 filter instructions. A typical program for FIR filter using the FIR(COR) instruction is shown below:

| | |
|---|---|
| ; | Use of FIR instruction in interrupt service routine |
| ; | Tap order = N |
| ; | Rx pair = {R0, R1} R0 -> sample_buf, R1 -> |
| | coeff_array |
| ; | sample_first = sample_buf (initially) |
| ; | coefficients start at coeff_array n RAM |
| ; | mtag_stat stores the tag bit status for circular buffer |
| | operation |
| ; | sample_new is new sample data |
| ; | data_y = result of FIR |

| | | |
|---|---|---|
| L1 | MOV R5, (−2*N) | ;load circular buffer length |
| | | to R5 |
| L2 | MOV R1, coeff_array | ;point to beginning of |
| | | coeff memory |
| L3 | MOV MR, *R1 | ;initial coeff (h0) loaded to |
| | | multiplier register |
| L4 | MOV R0, sample_first | ;R2 initialized to first |
| | | sample RAM location |
| L5 | RPT 0 | ;y will be stored at accu- |
| | | mulators pointed by An |
| L6 | ZACS A0 | ;initiaiize y to zero |
| L7 | MOV STAT, mtag_stat | ;previous sample TAG |
| | | restored to status register |
| L8 | RPT N-2 | ;actual filter routine for N |
| | | tap filter |
| L9 | FIR A0, *R0 | ;FIR can be replaced by |
| | | COR |
| L10 | MOV mtag_stat, STAT | ;save TAG status for next |
| | | sample |
| L11 | MOV A2, sample_new | ;store new sample data in |
| | | sample buffer |
| L12 | MOV A2,*R0 | ; |
| L13 | MOV *R1, sample_first | ;this is the start of first |
| | | sample FIR |
| L14 | MOV A0, data_y, ++A | ;store result 16 bit result, |
| | | y |

; Other processing if required

IRET ;return from interrupt

A typical program for FIR filter using the FIR(COR) instruction is shown below:

| | |
|---|---|
| ; | Use of FIR instruction in interrupt service routine |
| ; | Tap order = N |
| ; | Rxeven = RO, RO -> sample_buf |
| ; | sample_first = sample_buf (intially) |
| ; | coefficients start at coeff_array in ROM |
| ; | mtag_stat stores the tag bit status for circular buffer |
| | operation |
| ; | sample_new is new sample data |
| ; | data_y = result of FIR |

| | | |
|---|---|---|
| L1 | MOV R5, (−2*N) | ;load circular buffer length |
| | | to R5 |
| L2 | MOV A2, coeff_array | ;point to beginning of |
| | | coeff memory in ROM |
| L3 | MOV A2, *A2 | ;lookup first value (h0) |
| L4 | MOV MR, A2 | ;initial coeff (h0) loaded to |
| | | multiplier register |
| L5 | MOV R2, sample_array | ;R2 initialized to first |
| | | sample RAM location |
| L6 | RPT 0 | ;y will be stored at accu- |
| | | mulators pointed by AN |
| L7 | ZACS A0 | ;initialize y to zero |
| L8 | MOV STAT, mtag_stat | ;previous sample TAG |
| | | restored to status register |
| L9 | RTP N-2 | ;actual filter routine for N |
| | | tap filter |
| L10 | FIRK A0, *R2 | ;FIRK can be replaced by |
| | | CORK |
| L11 | MOV mtag_stag, STAT | ;save TAG status for next |
| | | sample |
| L12 | MOV A2, sample_new | ;store new sample data in |
| | | sample buffer |
| L13 | MOV A2, *R2 | |
| L14 | MOV *R2, sample_first | ;this is the start of first |
| | | sample FIR |
| | MOV A0, data_y, ++A | ;store result 16 bit result, |
| | | y |
| | ;other processing if required | |
| | IRET | ;Return from interrupt |

Other features and details which are also contemplated for use in the preferred embodiments, but which are not necessary for practice of the claimed inventions, are disclosed in the following co-pending applications:

Att'y docket number TI-24705P, Ser. No.______—“Method for Insuring Security of Program Data in One-Time Programmable Memory”;

Att'y docket number TI-24707P, Ser. No.______—“Variable Word Length Data Memory”; and

Att'y docket number TI-24708P, Ser. No.______—“Low Cost Multiplier Block with Chain Capability”; and

Att'y docket number TI-24711P, Ser. No.______—“Flexible Accumulator Register File for Use in High Performance Microprocessors”.

All of these are commonly owned with the present application, and have effective filing dates which are simultaneous with that of the present application, and are herein incorporated by reference.

Telephone Answering Machine

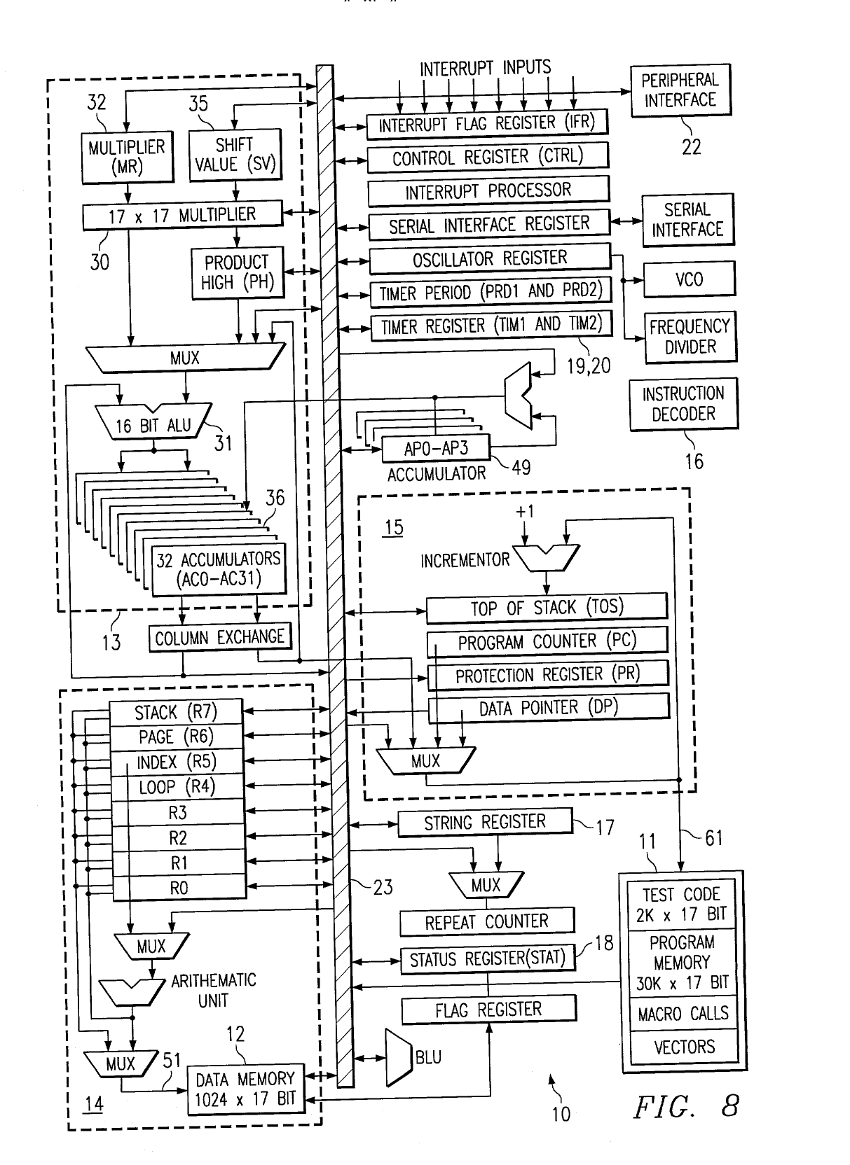

The variable length data memory, and the microprocessor in which it is incorporated, are designed for use in consumer electronics, such as telephone answering machines. A block diagram of an answering machine incorporating this invention is shown in FIG. 9. In this device, the processor 902 is operatively connected to a telephone line interface 904, a microphone 906, and a speaker 908. The microprocessor 902 receives and transmits sound data over the telephone line 910 via the telephone line interface 904. The microprocessor is also able to transmit sound data into the surrounding area via the speaker 908, and receive sound data from the surrounding area via the microphone 906.

According to a disclosed class of innovative embodiments, there is provided a programmable processing system comprising: a programmable processor, connected to execute stored instructions on a memory which includes, at each respective location, not only a plurality of data or program bits, but also at least one tag bit; wherein said processor is connected to execute at least some instructions which are dependent on said tag bit but not on said data or program bits.

According to another disclosed class of innovative embodiments, there is provided a variable length data memory array, comprising: a first memory array with one or more bits; a second memory array with one or more bits connected in parallel with said first memory array; and a plurality of multiplexors connected to read or write the appropriate bits of said arrays; wherein the contents of both said arrays can be read with one address but data is independently written to each said address.

According to another disclosed class of innovative embodiments, there is provided a variable length data memory array, comprising: a first memory array with one or more bits; a second memory array with one or more bits connected in parallel with said first memory array; a plurality of multiplexors connected to read or write the appropriate bits of said arrays; a single bit logic unit connected to receive data from said first memory array and execute instructions based on said data; wherein the contents of both said arrays can be read with one address and data is independently written to each said array using one address.

According to another disclosed class of innovative embodiments, there is provided a mixed signal processor chip, comprising: a central processing unit; a program memory operatively connected to said central processing unit; and a data memory consisting of two memory arrays connected in parallel and connected to said processor unit; wherein said two memory arrays can be read independently or simultaneously with the same address and said two memory arrays can be written independently using the same address.

According to another disclosed class of innovative embodiments, there is provided a telephone answering machine, comprising: a central processing unit; program memory operatively connected to said central processing unit; a data memory consisting of two memory arrays connected in parallel and connected to said processor unit; an interface operatively connecting said central processing unit to a telephone line in such a way as to receive and send messages; a microphone operatively connected to said central processing unit in such a way as to record sound for storage within the answering machine; and a speaker operatively connected to said central processing unit in such a way as to play back sounds stored within the answering machine; wherein said two memory arrays can be read independently or simultaneously with the same address and said two memory arrays can be written independently using the same address,.

Modifications and Variations

As will be recognized by those skilled in the art, the innovative concepts described in the present application can be modified and varied over a tremendous range of applications, and accordingly the scope of patented subject matter is not limited by any of the specific exemplary teachings given, but is only defined by the issued claims.

It should also be noted that, over time, an increasing number of functions tend to be combined into a single chip. The disclosed inventions can still be advantageous even with different allocations of functions among chips, as long as the functional principles of operation described above are still observed.

The presently preferred embodiment discloses a 1-bit plus 16-bit architecture. However, for specialized applications, other architectures such as 1-bit plus 32-bit or 1-bit plus 8-bit can take advantage of the disclosed innovations.

The presently preferred embodiment discloses a 1-bit plus 16-bit architecture. However, for specialized applications, other architectures where more than one bit is wired in parallel to a second memory array having a length eual to that of the word length of the processor architecture can take advantage of the disclosed innovations.

The instruction'which takes advantage of the disclosed variable length data memory enables flag/tag memory and logic processing. However, the variable length data memory functionality can be extended by the extension of the instruction utilizing the data memory. Other uses for the data memory may be obtained by such an extension. For example, use of the circular buffer can be extended beyond the implementation of FIR filters. Circular buffering can be used to move blocks of samples in the MSP without concern for the physical start or end of a particular memory block.

What is claimed is:

1. A programmable processing system comprising:
a programmable processor, connected to execute stored instructions on a memory which includes, at each respective location, not only a plurality of data or program bits, but also at least one tag bit;
wherein said processor is connected to execute at least some instructions which are dependent on said tag bit but not on said data or program bits.

2. A variable length data memory array, comprising:
a first memory array with one or more bits;
a second memory array with one or more bits connected in parallel with said first memory array; and
a plurality of multiplexors connected to read or write the appropriate bits of said arrays;
wherein the contents of both said arrays can be read with one address but data is independently written to each said address.

3. The variable length data memory array of claim 2, wherein both-said arrays are written with one address.

4. The variable length data memory array of claim 2, wherein said second memory array stores words that are 16 bits in length.

5. The variable length data memory array of claim 2, wherein said second memory address is more than 16 bits.

6. The variable length data memory array of claim 2, wherein first memory array is a single bit in length.

7. The variable length data memory array of claim 2, wherein contents of said second memory array are read into a separate register.

8. The variable length data memory array of claim 2, wherein the contents of said first memory array used as a data tag/flag.

9. The variable length data memory array of claim 2, wherein the contents of said first memory array defines a logical instruction.

10. The variable length data memory array of claim 2, wherein the contents of said first memory buffer defines an FIR sample buffer.

11. The variable length data memory array of claim 2, wherein said first memory array is accessed with the address of said second memory array.

12. A variable length data memory array, comprising:
a first memory array with one or more bits;
a second memory array with one or more bits connected in parallel with said first memory array;
a plurality of multiplexors connected to read or write the appropriate bits of said arrays;
a single bit logic unit connected to receive data from said first memory array and execute instructions based on said data;
wherein the contents of both said arrays can be read with one address and data is independently written to each said array using one address.

13. A mixed signal processor chip, comprising:
a central processing unit;
a program memory operatively connected to said central processing unit; and
a data memory consisting of two memory arrays connected in parallel and connected to said processor unit;
wherein said two memory arrays can be read independently or simultaneously with the same address and said two memory arrays can be written independently using the same address.

14. A telephone answering machine, comprising:
central processing unit;
program memory operatively connected to said central processing unit;
a data memory consisting of two memory arrays connected in parallel and connected to said processor unit;
an interface operatively connecting said central processing unit to a telephone line in such a way as to receive and send messages;
a microphone operatively connected to said central processing unit in such a way as to record sound for storage within the answering machine; and
a speaker operatively connected to said central processing unit in such a way as to play back sounds stored within the answering machine;
wherein said two memory arrays can be read independently or simultaneously with the same address and said two memory arrays can be written independently using the same address.
